(19) United States
(12) Patent Application Publication
(10) Pub. No.: US 2020/0169813 A1
(43) Pub. Date: May 28, 2020

(54) VIBRATING REED TYPE ULTRA-THIN FULL-FREQUENCY BONE CONDUCTION SPEAKER

(71) Applicant: Guangbiao CHEN, Guangdong (CN)

(72) Inventor: Guangbiao CHEN, Guangdong (CN)

(21) Appl. No.: 16/695,186

(22) Filed: Nov. 26, 2019

(30) Foreign Application Priority Data
Nov. 27, 2018 (CN) 201821967158.6

(51) Int. Cl. H04R 9/02; H04R 9/06

(52) U.S. Cl. CPC H04R 9/025; H04R 2400/11; H04R 9/06

(57) ABSTRACT

The utility model belongs to the field of audio transmission, and in particular to a vibrating reed type ultra-thin full-frequency bone conduction speaker. For problems that the existing speaker cannot make a sound via contact with a bone of a human body and then amplify the sound and change a frequency via stacking of an audio frequency in use, and the existing bone conduction speaker is slightly thicker under an equivalent effect, the following solution is provided. The vibrating reed type ultra-thin full-frequency bone conduction speaker includes a magnet portion; the magnet portion includes a U-shaped iron, a magnet and a washer; the magnet is attached to a lower surface of the U-shaped iron; the washer is attached to a lower surface of the magnet; both the magnet and the washer are located at a bottom of the U-shaped iron; and a long-arm vibrating reed and a tone tuning assembly are disposed under the magnet portion. The vibrating reed type ultra-thin full-frequency bone conduction speaker can greatly reduce the thickness of the product by adopting an overlapped structural design; effectively improve the sound sensitivity of sound and the bass effect to make the bass of the product more massive and comfortable by amplifying the diameter of a long-arm vibrating reed; and moreover, re-amplify and re-correct the frequency for the second time via changes of the tone tuning plate.

### BACKGROUND OF THE INVENTION

The utility model relates to the technical field of audio transmission, and in particular to a vibrating reed type ultra-thin full-frequency bone conduction speaker.

Most of sounds we hear are formed by transmission of sound waves in the air. The sound waves reaches inner ears of the cochlea via outer and middle ears. The sound waves may further be transmitted to the cochlea via direct vibration of the skull. For many earphones on the existing market, the speaker is used to stuff into human ears or made into an earshield shape, resulting in: firstly, it is easy to damage the eardrum of ears; secondly, when we use the earphones, we stuff them into our ears, so that the hearing may be greatly reduced after a long-term use; and thirdly, our ears cannot be liberated.

The bone conduction is to transmit the sounds to the inner ears via the skull. The bone nerve conduction vibrator is a converter capable of directly converting electrical signals into mechanical signals. The bone nerve conduction vibrator is a new world standard of the audio field on the mobile device. It provides an accurate broadband sound to output to a user, and is always ready to send a new audio frequency. The creation of the bone nerve conduction vibrator is to transmit the sounds via vibration but not to apply a pressure to surrounding air. The transmission of audio signals is very clear, so that the response of the brain is synchronous to the sounds.

At present, people have higher and higher requirements for sounds as well as the shapes and sounds of products, and hope products are thinner and have a better tone quality. However, the existing bone conduction product cannot be as smooth as the voice diaphragm of traditional speaker due to structure and material characteristics, the designed product is limited to a thickness of the traditional bone conduction speaker, and the products cannot meet the requirements of people. In this sense, the requirements for improvement is stronger and stronger. Therefore, a vibrating reed type ultra-thin full-frequency bone conduction speaker is provided.

### BRIEF SUMMARY OF THE INVENTION

The utility model provides a vibrating reed type ultra-thin full-frequency bone conduction speaker, to solve problems that the existing speaker cannot make a sound via contact with a bone of a human body and then amplify the sound and change a frequency via stacking of an audio frequency in use, and the existing speaker has poor bass effect.

To realize the above purpose, the utility model uses the following technical solution:

A vibrating reed type ultra-thin full-frequency bone conduction speaker includes a magnet portion, where the magnet portion includes a U-shaped iron, a magnet and a washer; the magnet is attached to a lower surface of the U-shaped iron; the washer is attached to a lower surface of the magnet; both the magnet and the washer are located at a bottom of the U-shaped iron; a long-arm vibrating reed and a tone tuning assembly are disposed under the magnet portion; the tone tuning assembly includes a voice coil and a tone tuning plate; the long-arm vibrating reed is located between the voice coil and the tone tuning plate; a through hole is provided on an upper surface of the long-arm vibrating reed; the long-arm vibrating reed is attached to an inner sidewall of the tone tuning plate; the voice coil is attached between an inner circle of the long-arm vibrating reed and an inner sidewall of a bottom of the tone tuning plate; and the magnet portion is attached to the voice coil and the inner circle of the long-arm vibrating reed.

Further, a fixed groove is provided in a middle of the lower surface of the U-shaped iron; the magnet is attached in the fixed groove; the washer is adhered on the surface of the magnet; and the U-shaped iron, the magnet and the washer are formed into a closed loop.

Specifically, the long-arm vibrating reed is made of a stainless steel material; the long-arm vibrating reed has a thickness in a range of 0.08-0.2 mm; and the long-arm vibrating reed includes an inner ring and an outer ring.

It is to be noted that a locating groove is provided in a middle of a bottom end of the tone tuning plate; and the voice coil is adhered in the locating groove.

In addition, the tone tuning plate is made of a non-magnetic metal material or a plastic engineering material.

Furthermore, a layer of plastic covers the outer ring of the long-arm vibrating reed; and the long-arm vibrating reed and the tone tuning plate are fixed via adhesion.

Preferably, the long-arm vibrating reed is fixed with the locating groove of the tone tuning plate via laser spot welding.

In the utility model

1: By adopting an overlapped structural design, the product thickness is greatly reduced; by amplifying the diameter of a long-arm vibrating reed, the sensitivity of t sound and the effect of a bass are effectively improved, and the bass of the product is more massive and comfortable.

2: The long-arm vibrating reed is disposed on an outer ring of a U-shaped iron, so that a part of the structure may be overlapped to achieve the purpose of reducing the product thickness; as an outer circle of the long-arm vibrating reed may be larger, the frequency response of a medium-low voice of the product is improved; and with the utilization of a shape of a tone tuning plate, the frequency response is adjusted for a second time to achieve the advantages of reducing the product thickness and improving the tone quality.

The vibrating reed type ultra-thin full-frequency bone conduction speaker can greatly reduce the thickness of the product by adopting an overlapped structural design; effectively improve the sound sensitivity of sound and the bass effect to make the bass of the product more massive and comfortable by amplifying the diameter of a long-arm vibrating reed; and moreover, re-amplify and re-correct the frequency for the second time via changes of the tone tuning plate to achieve the advantages of reducing the power consumption and improving the tone quality.

### BRIEF DESCRIPTION OF THE DRAWINGS

FIG. 1 is a structural exploded view of a pull plate of a vibrating reed type ultra-thin full-frequency bone conduction speaker according to the utility model.

FIG. 2 is a structural schematic diagram of a vibrating reed type ultra-thin full-frequency bone conduction speaker after a pull plate is installed according to the utility model.

FIG. 3 is an exploded view of a connecting structure between a U-shaped iron and a magnet of a vibrating reed type ultra-thin full-frequency bone conduction speaker according to the utility model.

FIG. 4 is a structural schematic diagram of a long-arm vibrating reed of a vibrating reed type ultra-thin full-frequency bone conduction speaker after being glued according to the utility model.

In the figure: 1. U-shaped iron, 101. fixed groove, 2. magnet, 3. washer, 4. voice coil, 5. long-arm vibrating reed, 51. inner circle, 52. outer circle, 6. tone tuning plate, and 61. locating groove.

### DETAILED DESCRIPTION OF THE INVENTION

The technical solution in the embodiments of the utility model is described below clearly and completely in combination with the accompanying drawings in the embodiments of the utility model. Apparently, the described embodiments are merely a part rather than all of the embodiments of the utility model.

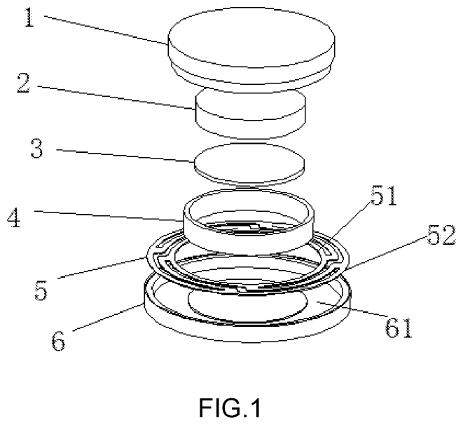

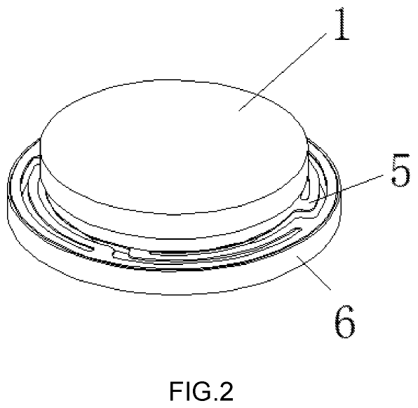

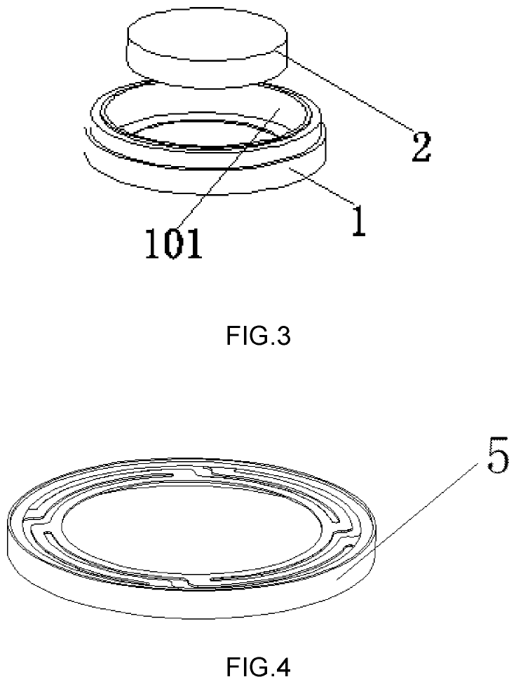

Referring to FIGS. 1-4, a vibrating reed type ultra-thin full-frequency bone conduction speaker includes a magnet portion, where the magnet portion includes a U-shaped iron 1, a magnet 2 and a washer 3; the magnet 2 is attached to a lower surface of the U-shaped iron 1; the washer 3 is attached to a lower surface of the magnet 2; both the magnet 2 and the washer 3 are located at a bottom of the U-shaped iron 1; a long-arm vibrating reed 5 and a tone tuning assembly are disposed under the magnet portion; the tone tuning assembly includes a voice coil 4 and a tone tuning plate 6; the long-arm vibrating reed 5 is located between the voice coil 4 and the tone tuning plate 6; a through hole is provided on an upper surface of the long-arm vibrating reed 5; the long-arm vibrating reed 5 is attached to an inner sidewall of the tone tuning plate 6; the voice coil 4 is attached between an inner circle of the long-arm vibrating reed 5 and an inner sidewall of a bottom of the tone tuning plate 6; and the magnet portion is attached to the voice coil 4 and the inner circle of the long-arm vibrating reed 5.

A fixed groove 101 is provided in a middle of the lower surface of the U-shaped iron 1; the magnet 2 is attached in the fixed groove 101; the washer 3 is adhered on the surface of the magnet 2; and the U-shaped iron 1, the magnet 2 and the washer 3 are formed into a closed loop. The long-arm vibrating reed 5 is made of a stainless steel material; the long-arm vibrating reed 5 has a thickness in a range of 0.08-0.2 mm; and the long-arm vibrating reed 5 includes an inner ring 51 and an outer ring 52. A locating groove 61 is provided in a middle of a bottom end of the tone tuning plate 6; and the voice coil 4 is adhered in the locating groove 61. The tone tuning plate 6 is made of a non-magnetic metal material or a plastic engineering material. A layer of plastic covers the outer ring of the long-arm vibrating reed 5; and the long-arm vibrating reed 5 and the tone tuning plate 6 are fixed via adhesion. The long-arm vibrating reed 5 is fixed with the locating groove 61 of the tone tuning plate 6 via laser spot welding.

The inner ring of the long-arm vibrating reed 5 is placed into the fixed groove 101 of the U-shaped iron 1, and welded firmly by means of laser spot welding, the magnet 2 is placed into the fixed groove 101 via a jig, and the long-arm vibrating reed 5 is located between the voice coil 4 and the washer 3. Therefore, the overall height of the vibrating reed type ultra-thin full-frequency bone conduction speaker may be reduced. Further, the laser spot welding is implemented first by means of the fixed groove 101 of the U-shaped iron 1, so that the inner ring 51 of the long-arm vibrating reed 5 is placed into the fixed groove 101 of the U-shaped iron.

Further, the outer ring 52 of the long-arm vibrating reed 5 is placed into the fixed groove 61 of the tone tuning assembly, and adhered in a glue, welding or encapsulating manner; the inner ring 51 of the long-arm vibrating reed 5 is placed into the locating groove 101, and adhered in the glue, welding or encapsulating manner; and a gap that is more than 0.5 mm is kept between an inner bottom of the tone tuning plate 6 and a top of the washer 3.

In the description of the utility model, it should be understood that, orientation or position relationships indicated by the terms “center”, “longitudinal”, “transversal”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, etc. are based on the orientation or position relationships as shown in the drawings, for ease of the description of the utility model and simplifying the description only, rather than indicating or implying that the indicated device or element must have a particular orientation or be constructed and operated in a particular orientation. Therefore, these terms should not be understood as a limitation to the utility model.

In addition, the terms such as “first” and “second” are merely for a descriptive purpose, and cannot be understood as indicating or implying relative importance, or implicitly indicating the number of the indicated technical features. Hence, the features defined by “first” and “second” can explicitly or implicitly include one or more features. In the description of the utility model, “a plurality of” means two or more, unless otherwise stated.

Embodiment: as a voice coil 4 is placed into a magnetic field of a magnet portion, when a current produced by an audio signal passes through the voice coil 4, the voice coil 4 generates a changeable magnetic field due to the change of the current, thus interacting with a permanent magnetic field produced by the magnet portion and producing the vibration. The shapes of a long-arm vibrating reed 5 and a tone tuning plate 6 may be changed, so that different frequencies of vibration are produced to convert an audio frequency of a sound generator into mechanical vibration and enable a skull of a human body to produce a resonance; and therefore, the audio frequency is transmitted to an auditory nerve system to restore into a sound. The design is simple and quick. By adopting an overlapped structural design characteristic, the product thickness is greatly reduced; by amplifying the diameter of a long-arm vibrating reed, the sensitivity of a sound and the effect of a bass are effectively improved, and the bass of the product is more massive and comfortable; and moreover, the frequency is re-amplified and re-corrected for a second time via a change of a tone tuning plate to achieve the advantages of reducing the power consumption and improving the tone quality.

The above are merely a preferred and specific implementation manner of the utility model, and the protection scope of the utility model is not limited thereto. Any equivalent replacement or modification made by a person skilled in the art according to the technical solution and concept of the utility model within a technical scope of the utility model should be included in the protection scope of the utility model.

What is claimed is:

1. A vibrating reed type ultra-thin full-frequency bone conduction speaker, comprising a magnet portion, wherein the magnet portion comprises a U-shaped iron (1), a magnet (2) and a washer (3); the magnet (2) is attached to a lower surface of the U-shaped iron (1); the washer (3) is attached to a lower surface of the magnet (2); both the magnet (2) and the washer (3) are located at a bottom of the U-shaped iron (1); a long-arm vibrating reed (5) and a tone tuning assembly are disposed under the magnet portion; the tone tuning assembly comprises a voice coil (4) and a tone tuning plate (6); the long-arm vibrating reed (5) is located between the voice coil (4) and the tone tuning plate (6); a through hole is provided on an upper surface of the long-arm vibrating reed (5); the long-arm vibrating reed (5) is attached to an inner sidewall of the tone tuning plate (6); the voice coil (4) is attached between an inner circle of the long-arm vibrating reed (5) and an inner sidewall of a bottom of the tone tuning plate (6); and the magnet portion is attached to the voice coil (4) and the inner circle of the long-arm vibrating reed (5).

2. The vibrating reed type ultra-thin full-frequency bone conduction speaker according to claim 1, wherein a fixed groove (101) is provided in a middle of the lower surface of the U-shaped iron (1); the magnet (2) is attached in the fixed groove (101); the washer (3) is adhered on the surface of the magnet (2); and the U-shaped iron (1), the magnet (2) and the washer (3) are formed into a closed loop.

3. The vibrating reed type ultra-thin full-frequency bone conduction speaker according to claim 1, wherein the long-arm vibrating reed (5) is made of a stainless steel material; the long-arm vibrating reed (5) has a thickness in a range of 0.08-0.2 mm; and the long-arm vibrating reed (5) comprises an inner ring (51) and an outer ring (52).

4. The vibrating reed type ultra-thin full-frequency bone conduction speaker according to claim 1, wherein a locating groove (61) is provided in a middle of a bottom end of the tone tuning plate (6); and the voice coil (4) is adhered in the locating groove (61).

5. The vibrating reed type ultra-thin full-frequency bone conduction speaker according to claim 1, wherein the tone tuning plate (6) is made of a non-magnetic metal material or a plastic engineering material.

6. The vibrating reed type ultra-thin full-frequency bone conduction speaker according to claim 3, wherein a layer of plastic covers the outer ring of the long-arm vibrating reed (5); and the long-arm vibrating reed (5) and the tone tuning plate (6) are fixed via adhesion.

7. The vibrating reed type ultra-thin full-frequency bone conduction speaker according to claim 3, wherein the long-arm vibrating reed (5) is fixed with the locating groove (61) of the tone tuning plate (6) via laser spot welding.
